(19) United States
(12) Patent Application Publication
(10) Pub. No.: US 2020/0361783 A1
(43) Pub. Date: Nov. 19, 2020

(54) SULFIDATED NANOSCALE ZERO VALENT IRON PARTICLE AS WELL AS PREPARATION METHOD AND APPLICATION THEREOF

(71) Applicant: Guangzhou Institute of Geochemistry, Chinese Academy of Sciences, Guangzhou (CN)

(72) Inventors: Yin ZHONG, Guangdong (CN); Heli WANG, Guangdong (CN); Xifen ZHU, Guangdong (CN); Dan Li, Guangdong (CN)

(21) Appl. No.: 16/870,495

(22) Filed: May 8, 2020

(30) Foreign Application Priority Data
May 13, 2019 (CN) 201910393183.0

(51) Int. Cl. C01G 49/12; B22F 9/24; C02F 1/70

(52) U.S. Cl. CPC C01G 49/12; B22F 9/24; C02F 2101/36; B22F 2301/35; C02F 1/705

(57) ABSTRACT

The present disclosure relates to a sulfidated nanoscale zero valent iron particle, as well as a preparation method and application thereof. The preparation method of the sulfidated nZVI particle includes the following steps: 1) ferrous salt is reacted with NaBH4 to prepare nZVI particles; and 2) mixing the nZVI particles with the elemental sulfur powder to prepare the iron sulfides layer-coated nZVI particles. The present disclosure uses elemental sulfur powder as a sulfur source for coating the nZVI particles. The reaction conditions are mild, easy to operate, and the production cost is low. Thus, the technical solution of the present disclosure is convenient for large-scale production, and the prepared sulfidated nZVI particles have high selectivity and reductive transformation capacity for target contaminants, and thus can be used in large-scale remediation of contaminated groundwater or soil.

### CROSS REFERENCE TO RELATED APPLICATIONS

This application is based on and claims the benefit of priority from Chinese Patent Application No. 201910393183.0, filed on May 13, 2019, the entirety of which is incorporated by reference herein.

### TECHNICAL FIELD

The present disclosure relates to a sulfidated nanoscale zero valent iron (S-nZVI) particle as well as preparation method and application thereof.

### BACKGROUND

Nanoscale zero valent iron (nZVI) particles are widely used in the treatment of contaminated groundwater and soil. The nZVI particles have the following advantages: 1) strong reduction capability; 2) little impact on the environment due to the fact that the particles per se will be converted to iron oxides after the treatment of pollutants; 3) small particle diameters, uniform particle sizes, and high specific surface area; 4) convenience in use. The nZVI particles can be injected into contaminated groundwater or soil through an injection well to perform in-situ remediation, and the particles can reach the finer aquifer material containing subsurface zones, so as to achieve more thorough purification of contaminated water.

However, the nZVI particles still have the following defects and deficiencies in the practical applications: 1) due to surface forces such as Van der Waals force and magnetic force, the nZVI particles tend to aggregate into particles with larger particle diameters, thereby greatly reducing the reactivity thereof; 2) during practical contaminant remediation processes, the nZVI particles have high reactivity and can randomly transfer electrons to electron acceptors such as H₂O, dissolved oxygen (DO) and nitrate (NO₃⁻), causing the loss of reduction capability of the nZVI particles, and reducing their selectivity towards target contaminants and reductive transformation efficiency.

In order to overcome the aforesaid defects and further improve the practical application effect of nZVI particles, current research mainly focuses on the following aspects:

1) Supported nZVI particles: porous materials (e.g., resin, carboxymethyl cellulose, and activated carbon) and inorganic clay minerals (e.g., montmorillonite, kaolinite, and bentonite) are used as carriers, and nZVI particles are supported by the carriers, thereby reducing the aggregation of the nZVI particles. Although the carriers can effectively reduce the aggregation of nZVI particles, the electron selectivity of the particles is not improved, and the corrosion rate by water is still relatively high.

2) Bimetallic nZVI particles: noble metals such as Pd or Ni, are added during the preparation process of nZVI particles to form a bimetallic system, so as to increase the active adsorption sites of the nZVI particles. Pd and Ni are excellent hydrogenation catalysts, and can adsorb hydrogen atoms (.H) on the surface of the particles and incorporated them into the lattice of the noble metal resulting in a substance with strong reducibility. Thus, the reduction and removal rates of nZVI particles on the contaminants adsorbed on the surface thereof are improved. However, the corrosion rate of the bimetallic nZVI particles by water is further increased. Meanwhile the noble metals such as Pd and Ni are expensive, and will be left in soil or sediment after use, which brings potential environmental risk. Therefore, the bimetallic nZVI particles have some problems such as poor electron selectivity and high corrosion rate. In practical applications, a high dose of the particles is required for achieving desired effect, which greatly increases the cost of contaminant remediation and limits its application.

3) Sulfidated nZVI particles: during the preparation process or after the synthesis of nZVI particles, a sulfiding agent is introduced to form a pyrite protective film on the surface of the nZVI particles. The pyrite contains delocalized electrons in its electronic layer, which is an excellent semiconductor material and can enhance the electron transfer ability of the nZVI particles. Further, the pyrite has certain hydrophobicity, and thus can promote Fe(0) to preferably transfer electrons to target contaminants, thereby improving the reductive transformation efficiency of the contaminants, inhibiting side reactions between the nZVI particles and water, slowing the corrosion rate of the nZVI particles, and improving the electron selectivity of the nZVI particles. Therefore, the sulfidated nZVI particles have the most promising application prospects.

At present, the sulfiding agents for synthesizing the sulfidated nZVI particles include Na₂S₂O₄ and Na₂S. However, Na₂S₂O₄ has certain oxidative activity, and can transform a large amount of Fe(0) to FeS, causing great loss of the initial reductive capacity of Fe(0). Meanwhile, Na₂S readily deliquesce in air and deteriorates by absorbing CO₂, and it will continuously release toxic H₂S. Therefore, the large-scale production and application of the sulfidated nZVI particles are greatly restricted.

### SUMMARY

An objective of the present disclosure is to provide a sulfidated nZVI particle as well as a preparation method and application thereof.

The technical solution adopted by the present disclosure is as follows.

A preparation method of sulfidated nZVI particles, which comprises steps of:

1) adding a ferrous salt solution to a reactor, further adding NaBH4 solution to initiate a reduction reaction, then standing for precipitation, removing supernatant, and rinsing a resulted solid to obtain nZVI particles; and

2) dispersing the nZVI particles in a solvent, adding elemental sulfur powder and mixing well, standing for a sufficient period, removing supernatant, and rinsing a resulted solid to obtain the sulfidated nZVI particles.

Preferably, the molar ratio of Fe2+ to NaBH4 in step 1) may be 1:(4-5).

Preferably, the ferrous salt in step 1) may be one selected from ferrous chloride, ferrous nitrate, and ferrous sulfate.

Further preferably, the ferrous salt in step 1) may be ferrous chloride.

Preferably, the concentration of the ferrous salt solution in step 1) may be 0.1 to 0.3 mol/L.

Preferably, the concentration of the NaBH4 solution in step 1) may be 0.2 to 0.4 mol/L.

Preferably, the NaBH4 solution in step 1) may be added dropwise to the reactor.

Preferably, the molar ratio of the elemental sulfur powder to the nZVI particles in step 2) may be (0.015-0.100): 1.

Further preferably, the molar ratio of the elemental sulfur powder to the nZVI particles in step 2) may be 0.025:1.

Preferably, the solvent in step 2) may be ethanol.

The beneficial effects achieved by the present disclosure are as follows. The present disclosure uses elemental sulfur powder as a sulfur source for coating the nZVI particles, comprises reactions performed under mild conditions, is easy for operation, and has low production cost. Thus, the technical solution of the present disclosure is convenient for large-scale production, and the prepared sulfidated nZVI particles have high selectivity and reductive transformation capacity for target contaminants, and thus can be used in large-scale remediation of contaminated groundwater or soil.

### BRIEF DESCRIPTION OF THE DRAWING

FIG. 1 is a scanning electron microscope (SEM) image of nZVI particles.

FIG. 2 is a SEM image of sulfidated nZVI particles.

FIG. 3 is an illustration showing the decomposition of TBBPA by nZVI and S-nZVI.

FIG. 4 is an illustration showing the dynamic changes of the intermediate products during the decomposition of TBBPA by nZVI.

FIG. 5 is an illustration showing the dynamic change of the intermediate products during the decomposition of TBBPA by S-nZVI.

FIG. 6 is an illustration showing the decomposition of TBBPA from different water bodies by S-nZVI and nZVI.

FIG. 7 is an illustration showing the decomposition of TBBPA by nZVI and S-nZVI of different S/Fe molar ratios.

### DETAILED DESCRIPTION OF THE PREFERRED EMBODIMENTS

The present disclosure will be further explained and illustrated below with reference to specific examples.

### Example 1

A preparation method of sulfidated nZVI particles comprises the following steps:

1) Adding 60 mL of 0.2 mol/L FeCl₂ solution to a reactor, adding dropwise 180 mL of 0.3 mol/L NaBH₄ solution to the FeCl₂ solution with stirring; after the dropwise addition, continuing to stir for 15 min, then standing for precipitation, removing the supernatant, and rinsing the resulted solid 4 times with high-purity water to obtain the nZVI particles; and

2) Dispersing the nZVI particles in 420 mL of ethanol, adding 0.0096 g of elemental sulfur powder (the molar ratio of elemental sulfur powder to the nZVI particles is 0.025:1), stirring for 12 h, and then allowing to stand for a sufficient period, removing the supernatant, and rinsing the resulted solid 4 times with ethanol to obtain the sulfidated nZVI (S-nZVI) particles.

### Performance Test:

### 1) Morphology Test:

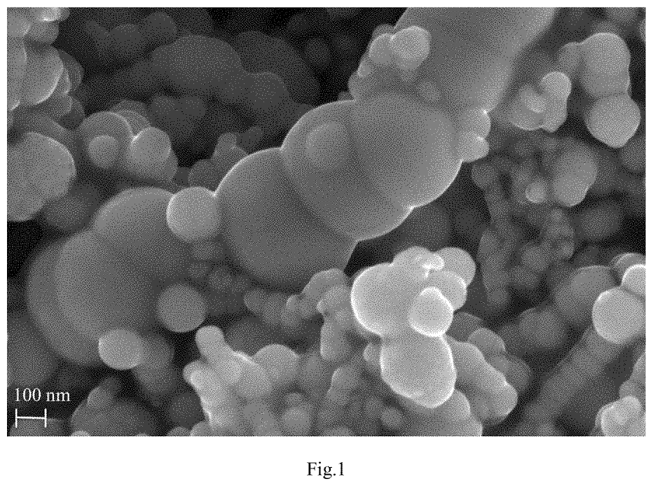

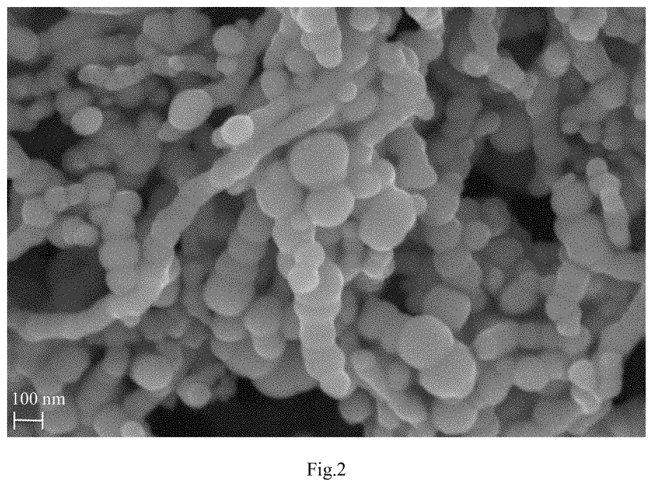

The nZVI particles prepared in step 1) and the S-nZVI particles prepared in step 2) were dispersed in ethanol, respectively, and were observed by scanning electron microscope (SEM). The obtained SEM images are shown in FIGS. 1 and 2.

It can be seen from FIG. 1 that the nZVI particles are obviously aggregated in a chain-like structure.

It can be seen from FIG. 2 that the aggregation of the nZVI particles can be significantly reduced by coating with elemental sulfur powder, and the obtained S-nZVI particles have smaller particle diameters and higher surface roughness.

2) Test on Effects of nZVI and S-nZVI on Decomposition of TBBPA:

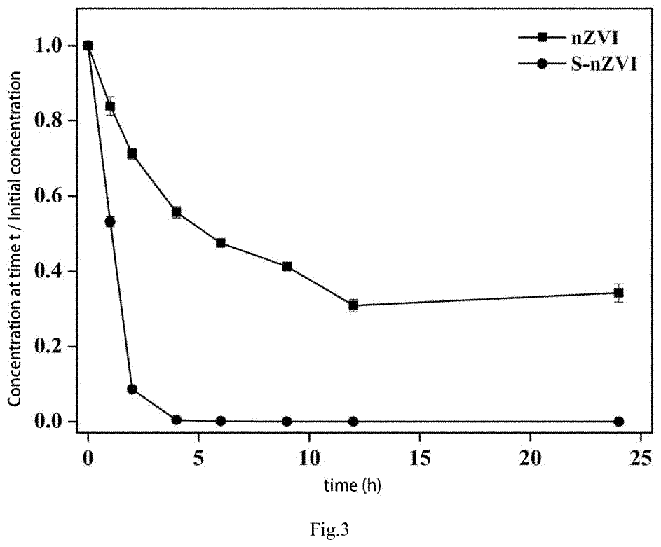

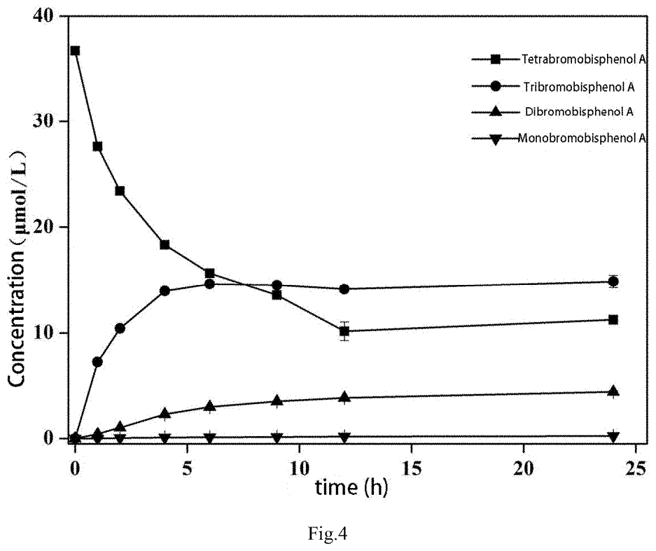

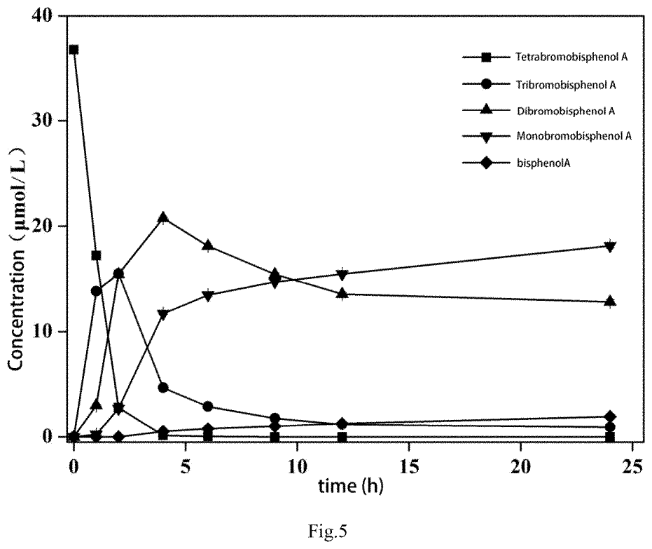

The solution of nZVI particles in ethanol and the solution of TBBPA (tetrabromobisphenol A) in methanol were added to an anaerobic reaction flask, and then deionized water was added to obtain a reaction solution with nZVI of 2.3 g/L and TBBPA of 20 ppm (36.77 μmol/L). The reaction solution was stirred at 30° C. At determined intervals, an aliquot of reaction solution was sampled, and 5 mol/L of HCl solution was added to completely dissolve nZVI particles. The reaction between nZVI and TBBPA was terminated, and 1 mL of methanol was added to increase the solubility of TBBPA in the solution. The residual concentration of TBBPA in the sample was determined by high performance liquid chromatography (Shimadzu LC-20A, Japan). The concentrations of various decomposition products of TBBPA in the sample were determined by liquid chromatography-electrospray triple quadrupole mass spectrometry (Agilent LC-ESI-MS/MS). Then a reaction solution was formulated with S-nZVI of 2.3 g/L and TBBPA of 20 ppm, and the S-nZVI particles were tested by means of the same process as that of the nZVI particles. The effects of nZVI and S-nZVI on the decomposition of TBBPA are shown in FIG. 3. The dynamic changes of intermediate products during the decomposition of TBBPA by nZVI are shown in FIG. 4, and the dynamic changes of intermediate products during the decomposition of TBBPA by S-nZVI are as shown in FIG. 5.

It can be seen from FIG. 3 that, after reacting for 4 hours, the removal rate of TBBPA by S-nZVI reaches 100%, while the removal rate of TBBPA by nZVI is only about 40%. After reacting for 12 hours, the removal rate of TBBPA by nZVI is only about 70%, and is no longer increased, indicating that the effect of S-nZVI on TBBPA removal is more excellent.

It can be seen from FIG. 4 that after reacting for 24 hours, the decomposition products of TBBPA by nZVI are mainly tribromobisphenol A.

It can be seen from FIG. 5 that after reacting for 24 hours, the decomposition products of TBBPA by S-nZVI are mainly dibromobisphenol A and monobromobisphenol A, and comprise a small amount of non-brominated product, bisphenol A. It indicates that S-nZVI has excellent debromination effect.

3) Test on Effects of nZVI and S-nZVI on Decomposition of TBBPA in Different Water Bodies:

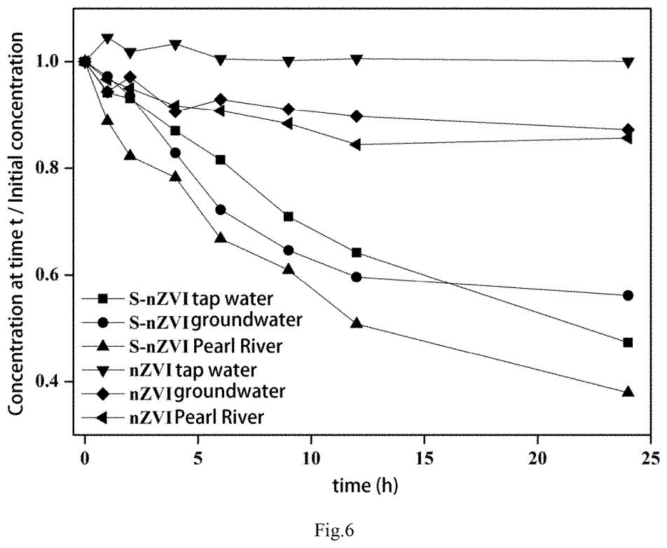

The solution of nZVI in ethanol and the solution of TBBPA in methanol were added to a anaerobic reaction flask, and then tap water was added to obtain a reaction solution with nZVI of 2.3 g/L and TBBPA of 5 ppm (9.19 μmol/L). The reaction solution was stirred at 30° C. At determined intervals, an aliquot of reaction solution was sampled, and 5 mol/L of HCl solution was added to completely dissolve nZVI particles. Then the reaction between ZVI and TBBPA was terminated, and 1 mL of methanol was added to increase the solubility of TBBPA in the solution. The residual concentration of TBBPA in the sample was determined by high performance liquid chromatography (Shimadzu LC-20A, Japan). The same testing process was applied for investigating the effect of nZVI on the decomposition of TBBPA in groundwater, the effect of nZVI on the decomposition of TBBPA in Pearl River water, the effect of S-nZVI on the decomposition of TBBPA in tap water, the effect of S-nZVI on the decomposition of TBBPA in groundwater, and the effect of S-nZVI on the decomposition of TBBPA in Pearl River water, except that the tap water was replaced with groundwater or Pearl River water, and nZVI was replaced with S-nZVI. The test results are shown in FIG. 6.

It can be seen from FIG. 6 that S-nZVI has significantly better effect on the decomposition of TBBPA in tap water, groundwater and Pearl River water than that of nZVI.

### Example 2

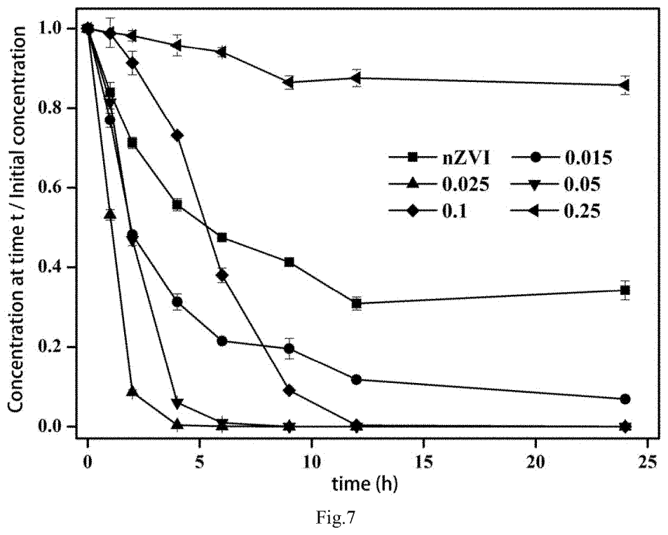

Referring to the preparation method of Example 1, the molar ratios of elemental sulfur powder to the nZVI particles (abbr. S/Fe molar ratio, which were 0.015:1, 0.025:1, 0.05:1, 0.1:1, and 0.25:1, respectively) were adjusted to prepare S-nZVI with different S/Fe molar ratios. Then, the effects of S-nZVI with different S/Fe molar ratios and nZVI on the decomposition of TBBPA were tested with reference to the test processes of Example 1, and the test results are shown in FIG. 7.

It can be seen from FIG. 7 that the S-nZVI prepared at the molar ratio of elemental sulfur powder to the nZVI particles of 0.025:1, has the best effect on the decomposition of TBBPA.

The aforesaid examples are preferred embodiments of the present disclosure, but the embodiments of the present disclosure are not limited thereto. Any alterations, modifications, substitutions, combinations, and simplification made without departing from the scope and principle of the present disclosure should be equivalent alternations, and all are included in the protection scope of the present disclosure.

What is claimed is:

1. A preparation method of sulfidated nanoscale zero valent iron (S-nZVI) particles, comprising the following steps:
1) adding a ferrous salt solution to a reactor, further adding NaBH₄ solution to initiate a reduction reaction, then standing for precipitation, removing supernatant, and rinsing a resulted solid to obtain nZVI particles; and
2) dispersing the nZVI particles in a solvent, adding elemental sulfur powder and mixing well, standing for a sufficient period, removing supernatant, and rinsing a resulted solid to obtain the sulfidated nZVI particles.

2. The preparation method according to claim 1, wherein the molar ratio of Fe²⁺ to NaBH₄ in step 1) is 1:(4-5).

3. The preparation method according to claim 1, wherein the ferrous salt in step 1) is one selected from ferrous chloride, ferrous nitrate, and ferrous sulfate.

4. The preparation method according to claim 2, wherein the ferrous salt in step 1) is one selected from ferrous chloride, ferrous nitrate, and ferrous sulfate.

5. The preparation method according to claim 1, wherein the ferrous salt solution in step 1) has a concentration of 0.1 to 0.3 mol/L; and the NaBH₄ solution in step 1) has a concentration of 0.2 to 0.4 mol/L.

6. The preparation method according to claim 2, wherein the ferrous salt solution in step 1) has a concentration of 0.1 to 0.3 mol/L; and the NaBH₄ solution in step 1) has a concentration of 0.2 to 0.4 mol/L.

7. The preparation method according to claim 1, wherein the NaBH₄ solution in step 1) is added dropwise to the reactor.

8. The preparation method according to claim 2, wherein the NaBH₄ solution in step 1) is added dropwise to the reactor.

9. The preparation method according to claim 1, wherein the molar ratio of the elemental sulfur powder to the nZVI particles in step 2) is (0.015-0.100): 1.

10. The preparation method according to claim 1, wherein the solvent in step 2) is ethanol.

11. The preparation method according to claim 2, wherein the solvent in step 2) is ethanol.

12. The preparation method according to claim 6, wherein the solvent in step 2) is ethanol.

13. A sulfidated nanoscale zero valent iron (nZVI) particle prepared by the method according to claim 1.

14. The sulfidated nZVI particle according to claim 8, wherein the sulfidated nZVI particle has a particle diameter ranging from 50 to 200 nm.

15. Use of the sulfidated nanoscale zero valent iron (nZVI) particle according to claim 8 in decomposing halogenated organic compounds in wastewater.

16. Use of the sulfidated nanoscale zero valent iron (nZVI) particle according to claim 9 in decomposing halogenated organic compounds in wastewater.
